(19) United States
(12) Patent Application Publication
(10) Pub. No.: US 2010/0157333 A1
(43) Pub. Date: Jun. 24, 2010

(54) PRINTING APPARATUS AND PRINTING METHOD

(75) Inventor: Yusuke Komano, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/625,863

(22) Filed: Nov. 25, 2009

(30) Foreign Application Priority Data
Dec. 19, 2008 (JP) 2008-323800

(51) Int. Cl. H04N 1/60

(52) U.S. Cl. 358/1.9

(57) ABSTRACT

In an ink jet printing apparatus capable of performing a marginless printing, there is provided an ink jet printing apparatus and printing method of performing a dot count with accuracy. An ink jet printing apparatus includes a print medium edge position detecting device for detecting a position of at least any of a left edge, right edge, upper edge and lower edge of a print medium. Furthermore, it includes a replacing device for replacing an input data in a protruded region by a null data. Further, it includes a counting device for counting an ejecting dot number in a printing region after being replaced by a null data by using the replacing device.

### BACKGROUND OF THE INVENTION

1. Field of the Invention

The present invention relates to a printing apparatus and a printing method and, in particular, to a printing apparatus mounted with a print head ejecting a liquid and a printing method to be applied to this printing apparatus.

2. Description of the Related Art

In an ink jet printing apparatus, when a marginless printing is performed, there is the one in which a printing region is set up to a region outside a left edge, right edge, upper edge and lower edge of a print medium to perform a printing. In such an ink jet printing apparatus, as is illustrated in FIG. 8, a printing is performed by setting a printing region larger than a print medium such that a protruded region is formed around the print medium. In this manner, as such printing method of setting a printing region to the outside of a print medium, as a conventional technique, in Japanese Patent Laid-Open No. 2009-338303, there is proposed the one in which by detecting an edge of a print medium through the use of a sensor, the position of the print medium is obtained. As a result, in the printing region outside a print medium (Hereinafter, it is referred to as a protruded region), an ink to be ejected is much less. In particular, in Japanese Patent Laid-Open No. 2009-338303, there is proposed an ink jet printing apparatus in which data at a portion of the protruded region is replaced by a null data to form a printing.

Furthermore, in Japanese Patent Laid-Open No. 2004-322476, there is proposed the one in which an edge of a print medium is detected by a sensor and a printing region is set based on the edge having been detected, and printing is performed so as not to eject a dot in a protruded region.

In addition, in Japanese Patent Laid-Open No. 2006-168110, there is proposed an ink jet printing apparatus in which a paper width is detected by a paper width sensor, the paper width information having been detected is once held in a memory, and a printing data in a main scanning direction is set based on the paper width information to be read out from the memory.

However, in the printing method by using the above-described ink jet printing apparatus, although the position of a print medium is detected and a marginless printing can be performed based on the position of the print medium having been detected, it is difficult to make a dot count with accuracy with respect to this print medium at this time. In particular, in the ink jet printing apparatus disclosed in Japanese Patent Laid-Open No. 2004-338303, at the time of printing in a protruded region, a printing data at a portion of the protruded region is converted to a null data to perform a printing. At this time, a mechanism of performing a dot count of a printing apparatus counts dots of the null data, so that there may be some cases in which dots at the portion where no printing has actually been performed are counted and the larger number of dots than the number of dots having actually been ejected is counted. Therefore, for example, in the case in which the printing method according to the above-described marginless printing is applied to an ink jet printing apparatus in which the replacement of an ink tank is performed based on the dot number having been counted, the replacement may be made based on the dot number having been counted more than the actual number. In such case, the replacement of an ink tank is made although ink in an ink tank has not fully been used up yet, so that maintenance costs of an ink jet printing apparatus will be increased more than needed.

In addition, in the case in which a time period of waiting for drying of a print medium having been printed is determined based on the dot number having been ejected on the print medium, there is a possibility that the time period of waiting for drying of a print medium is determined based on the dot number having been counted more than the actual number. In this case, although a print medium is already in the dried state, since the print medium is left to stand further for drying of the print medium to continue to dry the print medium, a time period taken to be printed becomes longer and the efficiency of printing may be reduced.

### SUMMARY OF THE INVENTION

Then, in view of the above-mentioned situations, the present invention has an object of providing an ink jet printing apparatus and a printing method of performing a dot count with accuracy in an ink jet printing apparatus capable of performing a marginless printing.

According to a first aspect of the present invention, there is provided a printing apparatus in which an ink is ejected from a print head to a region on a print medium and a region outside a print medium based on an image data having a size not less than a size of a print medium to make a printing, the printing apparatus comprising: a detecting device for detecting a position of a print medium; a specifying device for specifying a data outside a print medium of the image data based on a position of the print medium having been detected by the detecting device and the image data; a replacing device for replacing a data having been specified by the specifying device by a null data; and a counting device for counting an ink droplet number to be ejected from the print head after being replaced by a null data by using the replacing device.

According to a second aspect of the present invention, there is provided a printing method of performing a printing using a printing apparatus in which an ink is ejected from a print head to a region on a print medium and a region outside a print medium based on an image data having a size not less than a size of a print medium, the printing method comprising the steps of: detecting step for detecting a position of a print medium; specifying step for specifying a data outside a print medium of the image data based on a position of the print medium having been detected in the detecting step and the image data; replacing step for replacing a data having been specified in the specifying step by a null data; and counting step for counting an ink droplet number to be ejected from the print head after being replaced by a null data in the replacing step.

According to a printing apparatus of the present invention, since the printing apparatus capable of performing a marginless printing does not perform a dot count with respect to a null data in a protruded region, it is possible to perform a dot count with accuracy with respect to the protruded region.

Further features of the present invention will become apparent from the following description of exemplary embodiments (with reference to the attached drawings).

### BRIEF DESCRIPTION OF THE DRAWINGS

FIG. 1 is a block diagram illustrating a circuit arrangement of an ink jet printing apparatus according to an embodiment of the present invention;

FIG. 2 is a diagram showing a relation between FIGS. 2A and 2B, and FIGS. 2A and 2B are block diagrams showing the flow of a printing data until a print head performs a printing by using a printing data having been inputted in the ink jet printing apparatus of FIG. 1;

FIG. 3 is a flowchart showing the flow of control until a print head is driven through a processing of a printing data at a printing data processing part, to thereby perform a printing;

FIG. 4 is a flowchart of showing the flow of control at the time of converting data from a multivalued data to a bitmap data;

FIG. 5 is a flowchart of showing the flow of control in processing at a received data control part;

FIG. 6 is a flowchart of showing the flow of control at the time when a printing data in a protruded region is replaced by Null data and a dot count processing is executed based on this printing data;

FIG. 7 is a perspective view of an ink jet printing apparatus according to the embodiment of the present invention; and

FIG. 8 is an explanatory view for explaining the relation between a print medium and a protruded region of a printing data.

### DESCRIPTION OF THE EMBODIMENTS

### (Description of Circuit Arrangement)

Hereinafter, a printing method using an ink jet printing apparatus according to an embodiment of the present invention will be described with reference to the drawings.

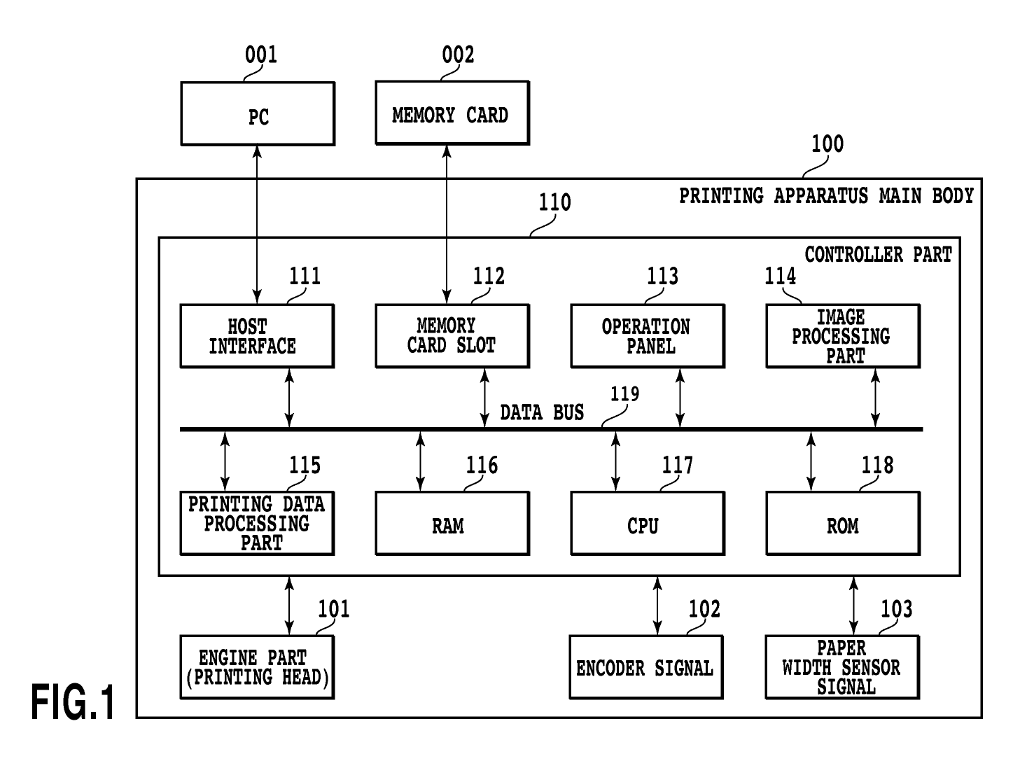

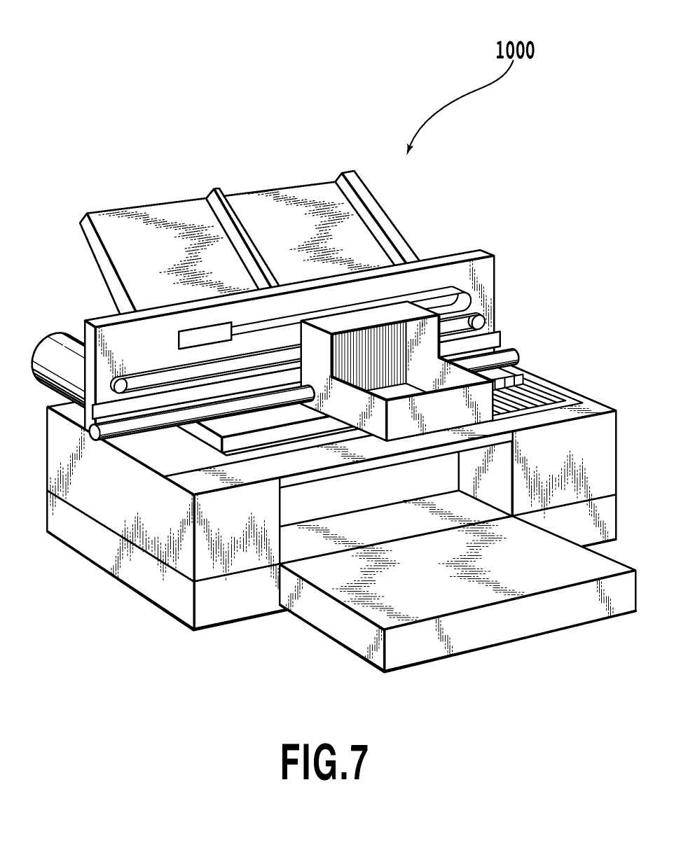

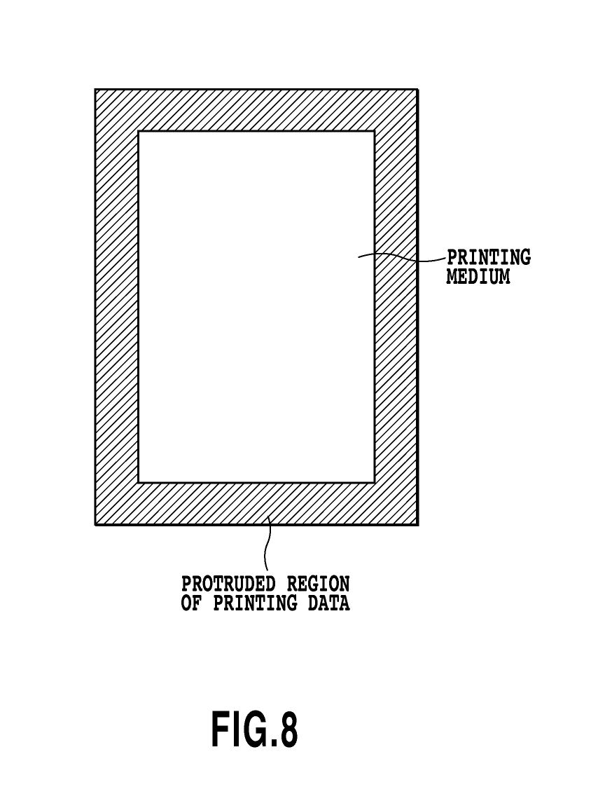

FIG. 7 shows a perspective view of an ink jet printing apparatus 1000 according to this embodiment. Hereinafter, an essential part of a control mechanism of the ink jet printing apparatus 1000 will be described with reference to the drawings. FIG. 1 illustrates a block diagram indicating a circuit arrangement of the ink jet printing apparatus according to the embodiment of the present invention. In the ink jet printing apparatus 1000 according to this embodiment, with respect to a region on a print medium and a protruded region protruding outward from the print medium, an ink is ejected as a liquid from the above-mentioned print head based on an input data having been inputted. As a result, a printing can be performed in a marginless printing mode of performing a printing without provision of a margin at end portions of the print medium. A printing apparatus main body 100 includes a controller part 110 and an engine part 101 as a component. Furthermore, the printing apparatus main body 100 includes an input part for receiving an input from a sensor such as an encoder signal 102 and a paper width sensor signal 103.

The controller part 110 receives externally a pixel data or a control command, based thereon, converts the pixel data to a printing data and transfers this printing data to the engine part 101 as a printing apparatus control command. The engine part 101 receives a control command for controlling the printing apparatus from the controller part 110, and based on this command, forms a visible image on a surface of print medium. Moreover, the controller part 110 communicates with the engine part 101 and transmits externally the condition of the engine part 101. In addition, the controller part 110 makes an overall control of the engine part 101.

Now, the controller pat 110 will be described in detail. The controller part 110 includes a host interface 111, a CPU 117, a RAM 116, a ROM 118, an image processing part 114, an operation panel 113, a memory card slot 112, a printing data processing part 115 and a data bus 119.

Sending and receiving of data is performed between the host interface 111 and external device (for example, a host computer). The ROM 118 stores a program of controlling the printing apparatus, various printing apparatus control languages, a font data and the like. The CPU 117 executes a program that is stored in the ROM 118 and makes a control of the entire apparatus, an analysis of a printing data, a creation of a bitmap data (In the present embodiment, the bitmap data is binary data.) and the like. The RAM 116 is used for temporary data storage such as storage of a pixel data having been sent externally, storage of a printing data, storage of various registered data, and the use as a work region of data processing.

The image processing part 114 converts data having been inputted to a pixel data suitable for printing. The operation panel 113 includes a key group and a display, with which parameters of printing environments are set, changed and displayed. A memory card 002 is a detachable external storage device, in which a variety of data such as an pixel data, character pattern data, printing form data and various programs are held. In this embodiment, the memory card 002 holds an pixel data. The memory card slot 112 is a connection part for connecting the memory card 002. Through the data bus 119, data to be sent or received in an internal part of the controller part 110 flows.

With the paper width sensor signal 103, by using a paper width sensor, at least information of the left and the right edge positions of a print medium is obtained. Depending on the arrangement of a paper width sensor, using the paper width sensor, the upper and the lower edge positions of the print medium can also be obtained as a paper width sensor signal.

### (Description as to Printing Data Processing Part)

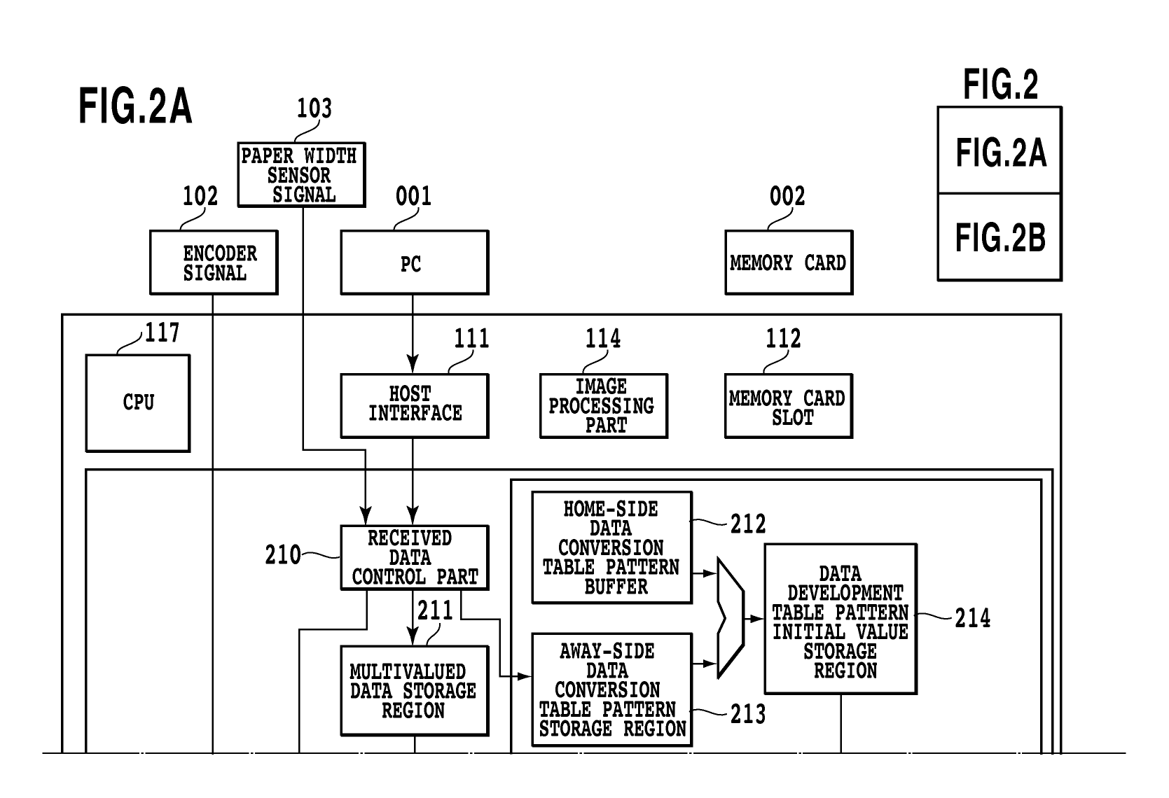

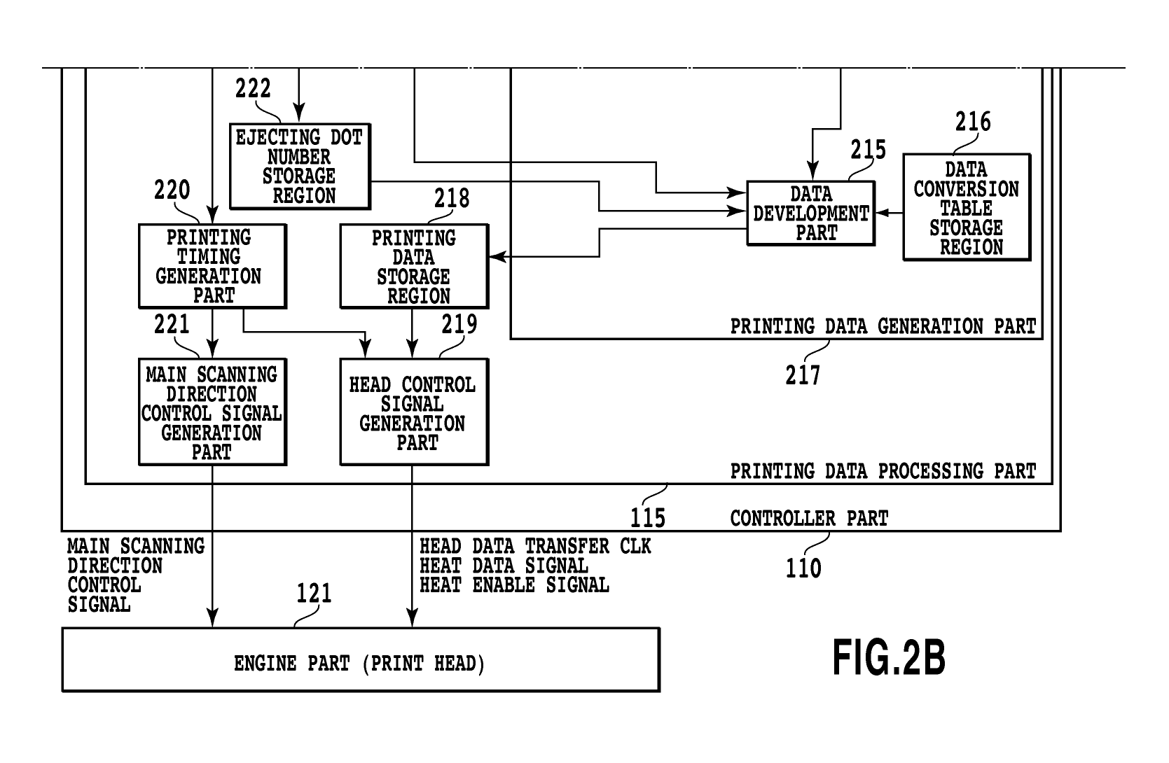

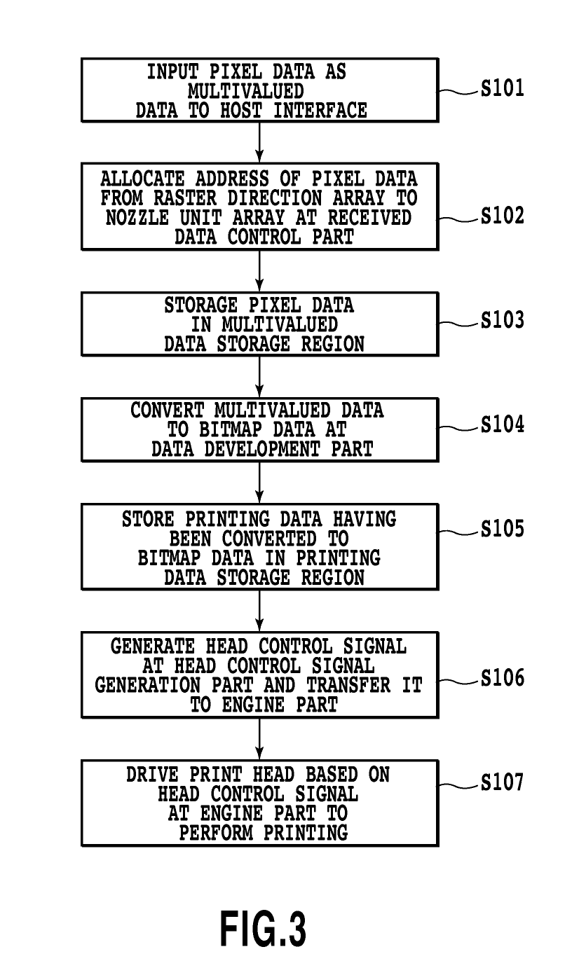

The printing data processing part 115 according to this embodiment will be described with reference to FIGS. 2A and 2B. FIGS. 2A and 2B are block diagrams showing the flow of a printing data until a print head performs a printing based on a printing data having been inputted by PC. In addition, the flow of control of an ink jet printing apparatus until a print head is driven to perform a printing through the processing at the printing data processing part of a printing data will be described with reference to FIG. 3.

The PC and the host interface 111 are connected to each other so that an pixel data as an input data from the PC is processed by a received data control part 210. The pixel data is input to the host interface 111 from the PC (S101). This pixel data is a multivalued data arranged in a raster direction. As the processing at the received data control part 210, in the received data control part 210, the address for this multivalued data is allocated from a raster direction array to a nozzle unit array (S102), to be stored in a multivalued data storage region 211 (3103). Although details of the received data control part 210 will be described below, as a processing in synchronization with the storage of data in the multivalued data storage region 211, the data is stored in an ejecting dot number storage region 222 and an AWAY-side data conversion table pattern storage region 213 as well.

A multivalued data, at the printing data processing part 115 after the received data control part 210, is converted to a bitmap data (S104). As this conversion method, there is a method in which a data conversion table is provided with respect to each value of the multivalued data to make a conversion while referring to this data conversion table. With the arrangement, the printing apparatus main body 100 includes a bitmap data conversion device configured to convert an input data as a multivalued data to a bitmap data. In this embodiment, the bitmap data conversion device is the CPU 117. Incidentally, the data amount of the bitmap data is larger than that of the multivalued data. Here, there occur fluctuations in the accuracy of impact position of a liquid droplet to be ejected depending on the difference table for use in data conversion at the time of printing, and uneven printing resulted from these fluctuations is required to be reduced. Therefore, in this embodiment, in the case where a multivalued data is 600 dpi in pixel number, there is employed a method in which the conversion to a bitmap data is allocated within 600 dpi.

Here, as the allocation method, the printing apparatus main body 100 includes data conversion tables having several kinds of patterns with respect to the same multivalued data. Further, by updating the kind of tables, there are provided several kinds of bitmap data to which the same multivalued data is converted. With the arrangement, in the RAM 116, plural patterns of tables are stored for allocating data with respect to the same multivalued data. In particular, the CPU 117 serving as dot allocating device, in the case in which the dot ejecting resolution at the time when a dot is ejected in by ejecting an ink onto a print medium by using a print head is higher than the resolution of an input data, allocates a dot ejecting region within the pixel of the input data. In addition, in this embodiment, the method of updating the pattern of a data conversion table employs the method of updating a data conversion table every time a multivalued data appears (hereinafter, it is referred to as data toggle).

At the time of executing data toggle by bidirectional printing, to equalize the pattern update orders of a data conversion table, there is required the same data conversion table initial value between scanning in a forward direction of a printing region and scanning in a reverse direction thereof. Furthermore, in the data conversion table thereafter, an update is made in the same order between the scanning in a forward direction of the printing region and the scanning in a reverse direction thereof. With the arrangement, a table is updated every time a printing data of a multivalued data appears. Here, the direction of moving in the forward direction from a home position of a print head in the scanning of printing operation is referred to as HOME side hereinafter, and the direction of moving in the reverse direction thereof is referred to as AWAY side hereinafter. This data conversion table initial value is held in a HOME-side data conversion table pattern buffer 212 and an AWAY-side data conversion table pattern storage region 213.

Here, in a data development table pattern initial value storage region 214, depending on the printing direction, a data conversion table value of either a data conversion table pattern register value buffer 212 or a data conversion table pattern storage region 213 is stored. Here, the printing direction is a raster direction to be developed in a data development part 215.

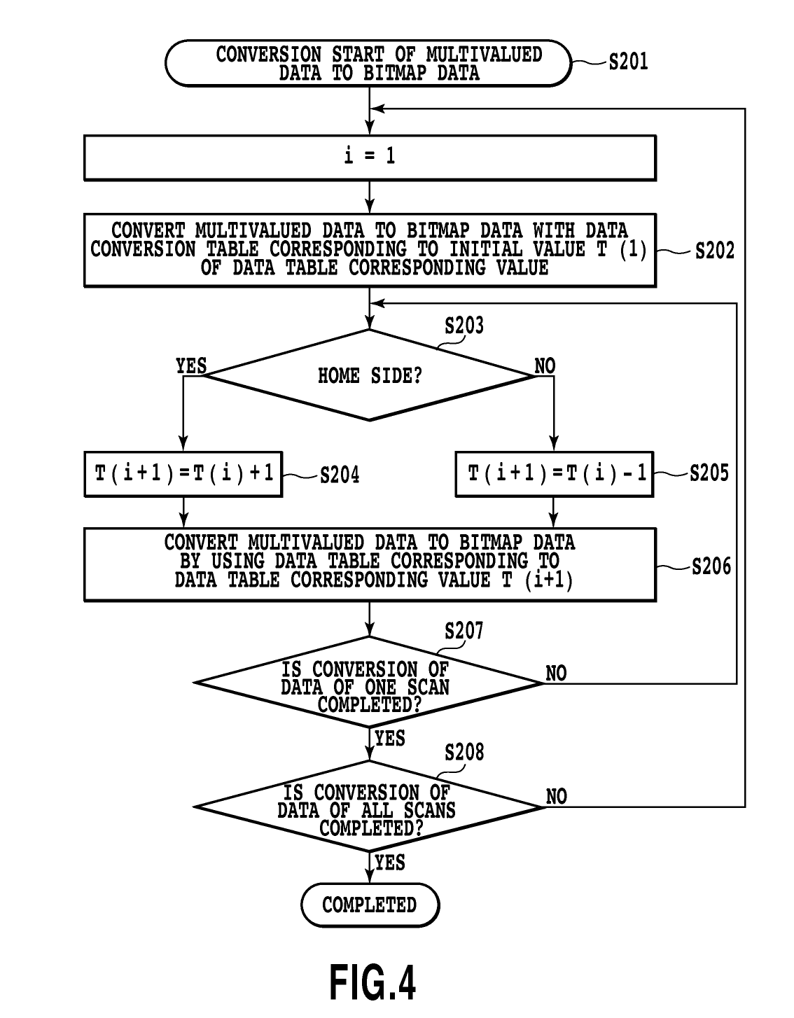

With the arrangement, the data development part 215 includes a device configured to convert a multivalued data to a bitmap data from an arbitrary raster end. The conversion from a multivalued data to a bitmap data will be described with reference to FIG. 4. Hereinafter, descriptions will be made, considering that a forward direction in the raster direction of data development is a direction from left to right on a page space.

In the case of printing in the forward direction, a multivalued data stored in the multivalued data storage region 211 is read from the left end on a page space. Then, at the time when a specified multivalued data appears first, an initial value is read from the HOME-side data conversion table pattern buffer 212 to the data development table pattern initial value storage region 219. That is, a data conversion table corresponding to an initial value T (1) of a data table corresponding value is read. Further, by using this initial value, with reference to the data conversion table from a data conversion table storage region 216, data conversion to a bitmap data is performed (S202). Next, with data that appears thereafter, a data conversion table of a pattern of a value obtained by adding 1 to the initial value is used (S204). Further, with reference to this data conversion table in the data conversion table storage region 216, data conversion to a bitmap data is performed (S206). That is, by letting a data table corresponding value T(i+1)=T(i)+1, and with reference to a data conversion table corresponding to the data table corresponding value T(i+1), data conversion to a bitmap data is performed. This operation is repeated to the right end (S207).

In the case of printing in the reverse direction, a multivalued data stored in the multivalued data storage region 211 is read from the right end on a page space. Then, at the time when a specified multivalued data appears first, an initial value is read from the AWAY-side data conversion table pattern storage region 213 to the data development table pattern initial value storage region 214. With the arrangement, a data conversion table corresponding to an initial value T (1) of a data table corresponding value is read. Further, by using this initial value, with reference to a data conversion table from the data conversion table storage region 216, data conversion to a bitmap data is performed. Next, with data that appears thereafter, a data conversion table of a pattern of a value obtained by subtracting 1 from the initial value is used (S205). Further, with reference to a data conversion table from the data conversion table storage region 216, data conversion to a bitmap data is performed (S206). That is, by letting a data table corresponding value T(i+1)=T(i)−1, and with reference to a data conversion table corresponding to the data table corresponding value T(i+1), data conversion to a bitmap data is performed. This operation is repeated to the left end (S207).

The flow of a printing data will be described in reference to a flowchart of FIG. 3. Data having been converted at the data development part 215 is stored in a printing data storage region 218 (S105). Further, from a printing timing having been generated at a printing timing generation part 220 by the encoder signal 101, and from a printing data in the printing data storage region, a head control signal is generated at a head control signal generation part 219 and transferred to the engine part (print head) 121 (S106). Here, a head control signal is a heat data, heat enable, head data transfer clock and the like. In addition, to the engine part 121, a main scanning direction control signal is transferred from a main scanning direction control signal generation part 221 having received the printing timing. Further, a head control signal is transferred to the engine part at the timing of this main scanning direction control signal (S107) to eject ink to a print medium.

### (Description as to Processing at a Received Data Control Part)

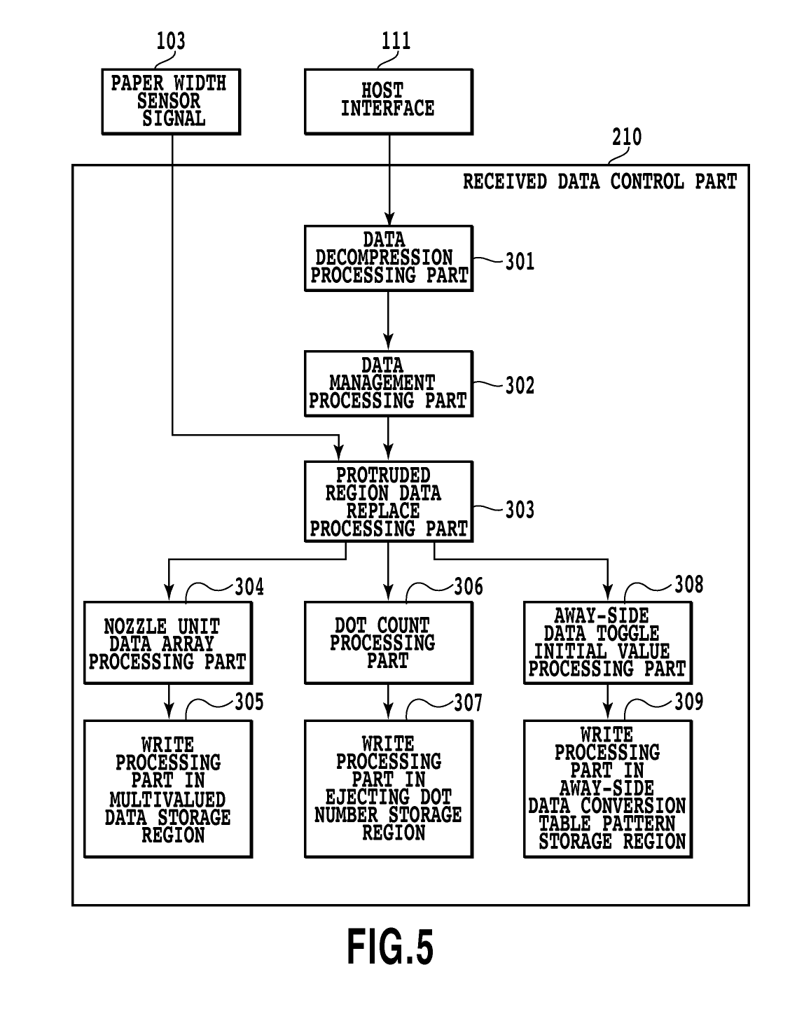

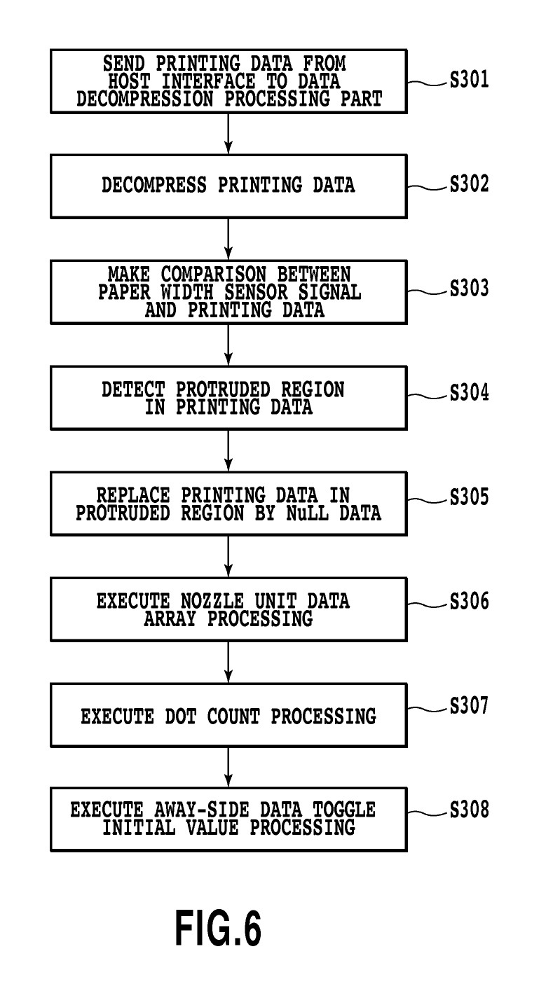

With reference to FIG. 5, processing at the received data control part 210 in this embodiment (S102) will be described further. As described above, an external input data from PC is input to a printing apparatus as a multivalued data in the order in a column direction to the host interface 111 (S301). In this embodiment, an input data is to be transmitted in the direction from the left end to the right end of a printing article. On this occasion, there are cases when data may be input in the state of being compressed in various ways. The input data is stored in a temporary storage region. In this embodiment, thereafter, the data having been stored in the temporary storage region is processed in a band width in 16 raster units corresponding to print heads of this embodiment.

Here, in the case in which data is a compressed data, it may be decompressed at a data decompression processing part 301 immediately after having been read out from the temporary storage region or in the case in which parameter setting suitable for not performing decompression is done at the time, it may be decompressed in the stage of being read out from the multivalued data storage region 211. Here, the description will be given under the condition that the decompression is performed at the data decompression processing part 301 immediately after read-out from the temporary storage region (S302). It is preferable that a multivalued data is converted to a bitmap data after having been decompressed in the case in which decompression is needed, or it is preferable that after a multivalued data has been read out from the multivalued data storage region 211, this multivalued data is converted to a bitmap data. FIG. 5 shows the flow of a printing data at the time of executing a decompression processing before conversion to a bitmap data.

As processing thereafter, a raster number and a column number of an input data will be managed at a data management processing part 302.

Here, in this embodiment, the width of a print medium has preliminarily been detected by a paper width sensor, and as a result of this detection, the paper width sensor signal 103 is obtained. The paper width sensor serves as a print medium edge position detecting device for detecting the position of the edge of a print medium. In this embodiment, the paper width sensor detects the position of at least any of a left edge, right edge, upper edge and lower edge of a print medium. Further, a comparison between a printing data and the paper width sensor signal 103 is made, and data in a protruded region of a printing data is detected. With the arrangement, the printing apparatus main body 100 includes a protruded region detecting device configured to determine whether or not there is present a printing region in a region other than a print medium by comparison between the position of a print medium having been detected by the paper width sensor and the printing region of a printing data. In this embodiment, the CPU 117 makes a comparison between the position of a print medium having been detected and the printing region of a printing data to detect a protruded region. In this embodiment, at a protruded region data replace processing part 303, a comparison is made between a paper width from the position at a left edge, right edge, upper edge and lower edge, being an input value from the paper width sensor signal 103, and a raster number and a column number of an input data that is managed at the data management processing part 302 (S303). As a result, a protruded region is specified in units of a pixel number (S304).

Further, data in a protruded region is replaced by Null data (S305). As a method of replacement of printing data by Null data, first an input data is sent from an upper left end, so that with respect to each input data, the pixel number from the upper left end is counted to thereby grasp the position of this input data. Furthermore, in the case in which a printing data is present in the protruded region, a printing data corresponding to the protruded region in data having been inputted is replaced by Null data. With the arrangement, the printing apparatus main body 100 includes a protruded region data replacing device for replacing an input data in the protruded region by a null data in the case in which there is present a protruded region, being a printing region of a region other than a print medium. In this embodiment, the protruded region data replacing device is the CPU 117.

As to processing after Null replacement, nozzle unit data array processing, dot count processing of counting a dot number in a predetermined area, and Away-side data toggle initial value processing for data toggle development of a multivalued data are executed. As to the nozzle unit data array processing, the printing data is stored in the multivalued data storage region 211, and is processed in addresses arrangement being converted between vertical direction and lateral direction.

Among these processing, first the nozzle unit data array processing will be described. Since the processing unit at the time when a print head is driven is in a raster direction, after read-out from the multivalued data storage region 211, it is desired to be arranged such that the aggregate of data in the raster direction is a processing unit. Therefore, as to the data having been subjected to Null replacement in the protruded region, at the time of storage in the multivalued data storage region 211, processing is performed in sequence in pixel units at the nozzle unit data array processing part (S306). Further, the data arrayed in the column direction is arranged such that the data is continuous in the raster direction in nozzle units at the time of read-out from the multivalued data storage region 211. With the arrangement, there is performed the operation in which a printing data arrayed in addresses continuous in the raster direction in nozzle units is stored at a write processing part in multivalued data storage region 305.

In this processing, the processing of conversion between vertical direction and lateral direction of data before Null replacement and the processing of conversion between vertical direction and lateral direction of data after Null replacement are in the same flow. That is, there is only a difference in whether or not a protruded region is replaced as Null data at the time when a printing data is stored in the multivalued data printing region 211. That is, a data flow can be used both in the case in which a protruded region is present and the case in which a protruded region is absent. Furthermore, the processing is configured such that also on the read-out side thereafter, there is no difference between both data flows, and that there is no need for considering whether or not Null replace processing has been made.

Next, dot count processing is executed (S307), Hereinafter, the dot count processing will be described. The dot number per a predetermined area is used at the time of determination of number of path division on printing or determination of a time period of waiting for drying of a print medium.

In this embodiment, in the case in which data is present in a protruded region, a dot number per area is counted at the dot count processing part 306 after replacement by Null is performed (S307). Here, a data input order of a printing data from the host interface 111 to the received data control part 210 is in the column direction in raster units. Further, writing is executed at a write processing part in ejecting dot number storage region 307 in raster units, and at the time of dot count processing of the next raster, by read-out of the dot number of the last raster from the write processing part in ejecting dot number storage region 307, dot number of the present raster is added to dot number of the last raster. By repeating this processing at predetermined times, a dot number per area can be stored in the ejecting dot number storage region 222. With the arrangement, the printing apparatus main body 100 includes a dot count device configured to count an ejecting dot number in a printing region after being replaced by a null data through the use of the protruded region data replacing device has been executed. In this embodiment, the dot count device is the CPU 117. By execution of the dot count processing with respect to the data having been subjected to Null replacement, dot count can be made so as not to count the dot number of data in the protruded region. Thus, in such a marginless printing mode of performing no printing with respect to a protruded region, the dot count can be made with accuracy. Consequently, it is possible to prevent an ink tank from being replaced although an ink has not been used up, and thus it is possible to suppress the maintenance cost of a printing apparatus. Furthermore, it is possible to properly determine the waiting time for being dried after printing and it is possible to prevent being kept waiting in vain for a long time, which allows the improvement of the printing efficiency and the reduction of a time period taken to be printed.

Subsequently, the data toggle processing is executed. Hereinafter, the data toggle processing will be described. Although the data toggle is as is described above, in this embodiment, the processing of obtaining an Away-side data toggle initial value is performed after Null replacement. In this embodiment, in the case in which data is present in a protruded region, the data toggle processing is executed at an Away-side data toggle initial value processing part 308 after being replaced by Null. Further, writing is executed at a write processing part in Away-side data conversion table pattern storage region 309 in the Away-side data conversion table pattern storage region 213 (S308). As to the data toggle processing, a proper data toggle can be made both in a printing mode of replacing a protruded region by Null and in a printing mode of not replacing a protruded region by Null. In this embodiment, however, the dot count is made after Null replacement. Further, at this time, the Null replacement is applied to the protruded region, and the data toggle processing is executed after Null replacement. As a result, in arrangement, the dot count processing and the data toggle processing can be executed in a common data flow. Thus, it becomes unnecessary to provide individual processing parts of executing the data toggle processing in the printing mode of replacing a protruded region by Null data and in the printing mode of not replacing a protruded region by Null data. As a result, the data toggle can be made at the common processing part. With the arrangement, a printing apparatus, as a result, has only to be provided with ASIC of small circuit scale, which allows the provision of an inexpensive printing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-323800, filed Dec. 19, 2008, which is hereby incorporated by reference herein in its entirety.

What is claimed is:

1. A printing apparatus in which an ink is ejected from a print head to a region on a print medium and a region outside a print medium based on an image data having a size not less than a size of a print medium to make a printing, the printing apparatus comprising:
a detecting device for detecting a position of a print medium;
a specifying device for specifying a data outside a print medium of the image data based on a position of the print medium having been detected by the detecting device and the image data;
a replacing device for replacing a data having been specified by the specifying device by a null data; and
a counting device for counting an ink droplet number to be ejected from the print head after being replaced by a null data by using the replacing device.

2. The printing apparatus according to claim 1, wherein the image data is a multivalued data, and further comprising a conversion device for converting a multivalued image data to a bitmap data.

3. The printing apparatus according to claim 2, wherein the conversion device converts an image data to a bitmap data based on a pattern in which an arrangement of a dot is determined with respect to each pixel of the image data.

4. The printing apparatus according to claim 3, wherein the conversion device performs a conversion by using a plurality of the patterns with respect to the same multivalued data.

5. The printing apparatus according to claim 4, wherein the conversion device updates the pattern with respect to each pixel of the image data.

6. A printing method of performing a printing using a printing apparatus in which an ink is ejected from a print head to a region on a print medium and a region outside a print medium based on an image data having a size not less than a size of a print medium, the printing method comprising the steps of:
detecting step for detecting a position of a print medium;
specifying step for specifying a data outside a print medium of the image data based on a position of the print medium having been detected in the detecting step and the image data;
replacing step for replacing a data having been specified in the specifying step by a null data; and
counting step for counting an ink droplet number to be ejected from the print head after being replaced by a null data in the replacing step.
